(19) United States
(12) Patent Application Publication
(10) Pub. No.: US 2020/0364003 A1
(43) Pub. Date: Nov. 19, 2020

(54) INFORMATION PROCESSING APPARATUS THAT ENABLES COMMUNICATION WITH IMAGE FORMING APPARATUS THAT HAS CONSUMABLE, IMAGE FORMING APPARATUS THAT HAS CONSUMABLE, AND CONTROL METHOD FOR IMAGE FORMING APPARATUS THAT HAS CONSUMABLE

(71) Applicant: CANON KABUSHIKI KAISHA, Tokyo (JP)

(72) Inventors: Kiyoharu Kakomura, Nagareyama-shi (JP); Takuya Hayakawa, Koshigaya-shi (JP); Seita Inoue, Kashiwa-shi (JP); Naoka Omura, Matsudo-shi (JP); Yuya Ohta, Abiko-shi (JP); Shunsuke Nishimura, Tokyo (JP); Yuichi Yamamoto, Nagareyama-shi (JP); Satoru Kojima, Kashiwa-shi (JP)

(21) Appl. No.: 16/847,291

(22) Filed: Apr. 13, 2020

(30) Foreign Application Priority Data
May 16, 2019 (JP) 2019-092905

(51) Int. Cl. G06F 3/12; G06Q 10/08

(52) U.S. Cl. CPC G06F 3/121; G06Q 10/087; G06F 3/1204; G06F 3/1229

(57) ABSTRACT

An information processing apparatus that is capable of reducing a delay of delivery of a consumable even if a history of a consumption amount of a consumable is erased. The information processing apparatus that enables communication with an image forming apparatus equipped with a replaceable consumable. The information processing apparatus includes a memory that stores data related to a consumption amount of the consumable, and a controller configured to determine a future change of a remaining amount of the consumable from the data stored in the memory, issue a delivery request that requests delivery of a replacement consumable according to the future change of the remaining amount of the consumable, and receive user instruction information. The controller issues the delivery request in a case where a predetermined condition related to the remaining amount is satisfied in a predetermined period from reception of the user instruction information.

### BACKGROUND OF THE INVENTION

### Field of the Invention

The present invention relates to an information processing apparatus that enables communication with an image forming apparatus that has a consumable, an image forming apparatus that has a consumable, and a control method for the image forming apparatus.

### Description of the Related Art

A maintenance system that manages consumables of an image forming apparatus generally consists of the image forming apparatus and a maintenance service server that are connected by a network, such as the Internet, in recent years. When detecting approach of replacement time, the image forming apparatus notifies the maintenance service server of a delivery request signal that requires delivery of the consumable. In response to the signal, the maintenance service server delivers the consumable to an office in which the image forming apparatus concerned is installed. Thereby, a user can obtain a new consumable.

A consumable in an image forming apparatus is a toner container that stores toner that is consumed by being used for a product, for example. Or a consumable is a photosensitive member that operates to generate a product. Hereinafter, these are generically called consumables. Particularly, when toner used for image formation is exhausted during use of an image forming apparatus, an expected product cannot be obtained. Accordingly, it is necessary to request delivery of a toner container before a toner remaining amount that is a remaining usable amount in the toner container is exhausted.

Japanese Laid-Open Patent Publication (Kokai) No. 2017-37596 (JP 2017-37596A) discloses a system that decides a reference toner remaining amount on the basis of a predicted toner remaining amount for every used day and delivery days and that issues a delivery request when an actual toner remaining amount becomes less than the reference toner remaining amount. This enables execution of the delivery request of a toner container according to a use mode of a user who uses an image forming apparatus. That is, a consumable can be delivered at suitable time by predicting the number of remaining days (hereinafter referred to as a remaining period) within which a toner container is usable from usage history that shows history of the consumption amount.

However, when a user is changed during use of a consumable, a problem may occur. For example, a case where an image forming apparatus is transferred to another section in a company will be considered. When an image forming apparatus is transferred to another section in a company, an equipped consumable is used continuously in many cases without being exchanged for a new consumable. In the meantime, a use mode of the consumable may change and a consumption speed may change largely after the transfer.

When the use mode changes largely, it is possible to erase past user's use history in order to extract a use history of a new user correctly. However, a certain length is needed for a predetermined period within which a use history is extracted in order to predict the remaining period of a consumable with high accuracy from the use history. A state where the remaining period of the consumable cannot be predicted continues until the predetermined period elapses after the use history is erased. When the use history is cleared in a state where a usable amount (remaining amount) of the consumable is few, a replacement time may come before extracting the use history. That is, since a delivery request cannot be issued in the state where the use history cannot be extracted, there is a problem that the delivery of the consumable may delay.

### SUMMARY OF THE INVENTION

The present invention provides an information processing apparatus, an image processing apparatus, and a control method therefor that are capable of reducing a delay of delivery of a consumable even if a history of a consumption amount of a consumable is erased.

Accordingly, a first aspect of the present invention provides an information processing apparatus that enables communication with an image forming apparatus that has a consumable. The information processing apparatus includes a memory that stores data related to a consumption amount of the consumable, and a controller configured to determine a future change of a remaining amount of the consumable from the data stored in the memory, output a delivery request that requests delivery of a replacement consumable based on the future change of the remaining amount of the consumable, and receive user instruction information. The controller outputs the delivery request in a case where a predetermined condition related to the remaining amount of the consumable is satisfied in a predetermined period from reception of the user instruction information.

Accordingly, a second aspect of the present invention provides an image forming apparatus that has a consumable including a memory that stores data related to a consumption amount of the consumable, and a controller configured to determine a future change of a remaining amount of the consumable from the data stored in the memory, output a delivery request that requests delivery of a replacement consumable based on the future change of the remaining amount of the consumable, and receive user instruction information. The controller outputs the delivery request in a case where a predetermined condition related to the remaining amount of the consumable is satisfied in a predetermined period from reception of the user instruction information.

Accordingly, a third aspect of the present invention provides a control method for an image forming apparatus that has a consumable and a memory storing data related to a consumption amount of the consumable. The control method includes determining a future change of a remaining amount of the consumable from the data stored in the memory, outputting a delivery request that requests delivery of a replacement consumable based on the future change of the remaining amount of the consumable, and receiving user instruction information. The delivery request is outputted in a case where a predetermined condition related to the remaining amount of the consumable is satisfied in a predetermined period from reception of the user instruction information.

According to the present invention, a delay of delivery of a consumable is reduceable even if a history of a consumption of a consumable is cleared.

Further features of the present invention will become apparent from the following description of exemplary embodiments with reference to the attached drawings.

### BRIEF DESCRIPTION OF THE DRAWINGS

FIG. 1 is a sectional view schematically showing an image forming apparatus according to a first embodiment of the present invention.

FIG. 2 is a sectional view showing a toner supply unit of the image forming apparatus shown in FIG. 1.

FIG. 3 is a block diagram showing a hardware configuration of the image forming apparatus shown in FIG. 1.

FIG. 4 is a flowchart showing a delivery management process executed by the image forming apparatus in FIG. 1.

FIG. 5 is a flowchart showing a toner-use-amount calculation process executed in the step S100 in FIG. 4.

FIG. 6A is a graph showing variation of a toner use amount per day by a certain user. FIG. 6B is a graph showing variation of a toner remaining amount.

FIG. 7 is a flowchart showing a feature amount calculation process executed in the step S102 in FIG. 4.

FIG. 8 is a flowchart showing a remaining-period calculation process executed in the step S103 in FIG. 4.

FIG. 9A and FIG. 9B are views showing specific examples for finding the number of remaining days (remaining period) by the remaining-period calculation process in FIG. 8.

FIG. 10 is a display example of a consumable management screen displayed on an operation panel of the image forming apparatus in FIG. 1.

FIG. 11 is a flowchart showing of a history erasure process executed by the image forming apparatus in FIG. 1.

FIG. 12 is a flowchart showing a delivery decision process executed in the step S104 in FIG. 4.

FIG. 13 is a flowchart showing a delivery decision process in a second embodiment of the present invention.

### DESCRIPTION OF THE EMBODIMENTS

Hereafter, embodiments according to the present invention will be described in detail by referring to the drawings. In the following embodiments, an image forming apparatus equipped with a replaceable consumable will be described.

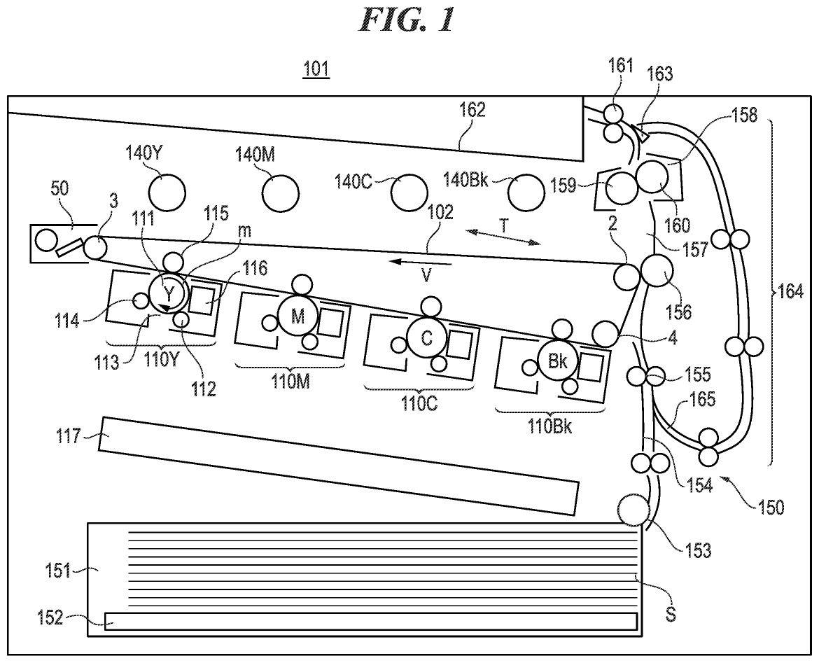

FIG. 1 is a sectional view schematically showing an image forming apparatus according to a first embodiment of the present invention. This image forming apparatus 101 is a color image forming apparatus using an electrophotographic system. It should be noted that the image forming apparatus 101 may use systems, such as an offset printing system and an ink jet system, other than the electrophotographic system. The image forming apparatus 101 is an image forming apparatus of what is called an intermediate transfer tandem system that has image forming units of four colors arranged along an intermediate transfer belt 102.

A sheet S as a recording material is stored so as to be stacked on a lift-up device 152 in a recording-material container 151, and is fed according to an image formation timing with a roller 153. It should be noted that a sheet-feeding method does not matter. The sheet S sent out with the roller 153 passes a conveyance path 154 and is conveyed to a registration roller pair 155. The registration roller pair 155 corrects a skew and a timing of the sheet S and then is sent to a secondary transfer section. This secondary transfer section is a transfer nip position formed between a drive roller 2 and an outer roller 156 that face mutually. A toner image on the intermediate transfer belt 102 is transferred onto the sheet S by giving predetermined pressure force and electrostatic load bias to the secondary transfer section.

An image forming process to the secondary transfer section performed at the same timing as a conveyance process of the sheet S to the secondary transfer section will be described. The image forming apparatus 101 has the image forming units 110Y, 110M, 110C, and 110Bk that form images with yellow (Y) toner, magenta (M) toner, cyan (C) toner, and black (Bk) toner, respectively. Since the image forming units 110Y, 110M, 110C, and 110Bk has the same configuration except the toner color, the image forming unit 110Y will be described as a representative.

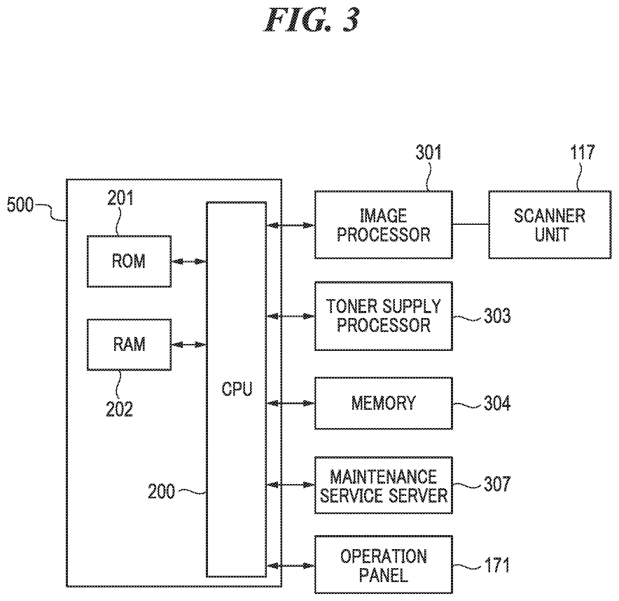

The image forming unit 110Y has a photosensitive member 111, an electrostatic charger 112 that charges the photosensitive member 111, an exposure opening 113, a development device 114, a primary transfer roller 115, and a photosensitive-member cleaner 116. The electrostatic charger 112 uniformly charges the surface of the photosensitive member 111 that rotates in a direction of an arrow m in FIG. 1. A scanner unit 117 including lasers, a polygon mirror, f-theta lenses, and folding mirrors outputs a plurality of laser beams modulated according to image pixel information transmitted from an image processor 301 (FIG. 3). The laser beams reflected by the folding mirrors are output towards the respective image forming units. An electrostatic latent image is formed because one of the laser beams exposes the charged photosensitive member 111 through the exposure opening 113. The electrostatic latent image formed on the photosensitive member 111 is developed by the development device 114 with electrostatically charged toner, so that a toner image is formed on the photosensitive member 111. After that, when the primary transfer roller 115 applies predetermined pressure force and electrostatic load bias to the toner image, the yellow toner image is transferred onto the intermediate transfer belt 102. After that, the excess toner remaining on the photosensitive member 111 is collected by the photosensitive-member cleaner 116 and is used for the following image formation.

A magenta toner image formed by the image forming unit 110M is transferred to the intermediate transfer belt 102 so as to be piled on the yellow toner image formed on the intermediate transfer belt 102. Furthermore, a cyan toner image formed by the image forming unit 110C is transferred to the intermediate transfer belt 102 so as to be piled on the magenta toner image. Furthermore, a black toner image formed by the image forming unit 110Bk is transferred to the intermediate transfer belt 102 so as to be piled on the cyan toner image. In this way, a full color image is formed on the intermediate transfer belt 102 because the different color toner images are formed in pile on the intermediate transfer belt 102. The number of colors is not limited to four and the arrangement order is not limited to the exemplified embodiment.

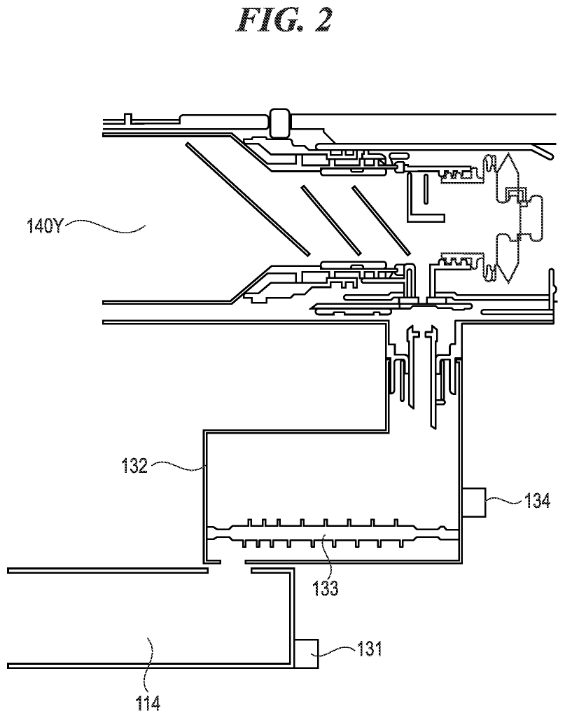

Moreover, toner bottles 140Y, 140M, 140C, and 140Bk that are replaceable toner containers are provided so as to respectively correspond to the image forming units 110Y, 110M, and 110C and 110Bk. The toner bottles 140Y, 140M, 140C, and 140Bk respectively contain yellow toner, magenta toner, cyan toner, and black toner. The toner bottles 140Y, 140M, 140C, and 140Bk are constituted so as to be detachable from bottle mounts (not shown) provided in the image forming apparatus 101. When each of the toner bottles 140Y, 140M, 140C, and 140Bk is attached to the bottle mount, a supply-port shutter provided in a supply port of each toner bottle is released. As described by referring to FIG. 2, the toner ejected from the supply port of the toner bottle 140Y is supplied to the corresponding development device 114. Each of the toner bottles 140Y, 140M, 140C, and 140Bk is a consumable that is replaced by a user or service person when it becomes unusable because the remaining amount of the contained toner becomes less than a first predetermined amount. The image forming units 110Y, 110M, 110C and 110Bk are units for forming images using the toners stored in the toner bottles 140Y, 140M, 140C, and 140Bk that are the consumables attached so as to be replaceable. Each of the image forming units also corresponds to an operation unit that operates using a consumable.

The intermediate transfer belt 102 is supported by the drive roller 2, a tension roller 3, and a roller 4 in a tensioned state. The drive roller 2 serves both as a drive member and a secondary transfer inner member. The tension roller 3 gives predetermined tension to the intermediate transfer belt 102. The roller 4 is a support member. The intermediate transfer belt 102 is a belt member that is driven and conveyed in a direction of an arrow V in FIG. 1. The roller 4 is arranged at an upstream side of the driving roller 2 in the conveyance direction V, and the tension roller 3 is arranged at a downstream side of the driving roller 2. The primary transfer roller 115 is arranged between the tension roller 3 and roller 4. The tension roller 3 and roller 4 are not driven directly and rotate by following the conveyance of the intermediate transfer belt 102.

The tension roller 3 is held so as to be movable in a direction, which is parallel to a plane formed by the intermediate transfer belt 102 supported between the tension roller 3 and roller 4, of an arrow T in FIG. 1 and is energized by a biasing means (not shown). This gives the tension to the intermediate transfer belt 102. The outer periphery of the drive roller 2 is formed with conductive EPDM so that the driving roller 2 is able to convey the intermediate transfer belt 102 with frictional force in the state where the tension roller 3 gives tension to the intermediate transfer belt 102. Moreover, an intermediate transfer cleaner 50 that removes the toner remained on the intermediate transfer belt 102 is attached stationary to the tension roller 3 at the side opposite to the tension roller 3 across the intermediate transfer belt 102.

The image forming processes of the respective colors are parallelly processed by the above-mentioned image forming units 110M, 110C, and 110Bk at the timings when toner images are piled on a toner image of an upstream color that is primarily transferred onto the intermediate transfer belt 102. As a result, a full color toner image is formed on the intermediate transfer belt 102 finally and is conveyed to the secondary transfer section.

The full color toner image formed on the intermediate transfer belt 102 is transferred onto the sheet S at the secondary transfer section. After that, the sheet S is conveyed to a fixing device 158 by a pre-fixing conveyance unit 157. The fixing device 158 gives predetermined pressure and heat to the sheet S at a fixing nip formed between a fixing roller 159 and pressure roller 160 that face each other and fusion-fixes the toner image on the sheet S. The fixing roller 159 includes a heater as a heat source. The pressure roller 160 is pressed toward the fixing roller 159. The sheet S that passes the fixing device 158 and is conveyed by a reversal roller pair 161 is discharged onto a tray 162 as-is.

When double-sided image formation is required, the sheet S is guided to a branching device 163, the front and rear ends of the sheet S are interchanged by a switch back operation by the reversal roller pair 161, and the sheet S is conveyed to a double-sided conveying path 164. After that, the sheet S is conveyed to the secondary transfer section again through the conveyance path 154 from a paper re-feeding path 165 at a timing decided by considering a timing of the following sheet conveyed from the roller 153. Since an image forming process for the back surface (second side) is the same as that for the front surface (first side), its description is omitted.

FIG. 2 is a sectional view the toner supply unit of the image forming apparatus 101. An operation that supplies the toner to the development device 114 from the toner bottle 140Y through a hopper 132 will be described by referring to FIG. 2. Since the operations of the corresponding components are common between the toner bottles 140Y, 140M, 140C, and 140Bk, the operation of the toner bottle 140Y will be described by referring to FIG. 2.

In the above-mentioned image forming process, a toner image is formed by consuming the toner stored in the development device 114. Accordingly, whenever the image forming process is performed, the toner amount in the development device 114 decreases. A sensor 131 provided in the development device 114 detects whether the amount of the toner stored in the development device 114 is equal to or more than a second predetermined amount When the amount of the toner in the development device 114 is less than the second predetermined amount, the toner stored in the hopper 132 connected with the development device 114 is supplied to the development device 114. A supply screw 133 is provided inside the hopper 132. When a CPU 200 (FIG. 3) controls a rotation amount of the supply screw 133, a fixed amount of toner is supplied to the development device 114 from the hopper 132.

When the toner amount stored in the hopper 132 is less than a third predetermined amount, the correct amount of toner cannot be supplied to the development device 114 even if the supply screw 133 rotates. A sensor 134 provided in the hopper 132 detects whether the amount of toner stored in the hopper 132 is equal to or more than the third predetermined amount. Then, when the amount of toner in the hopper 132 is less than the third predetermined amount, the toner stored in the toner bottle 140Y is supplied to the hopper 132. An inductance sensor that measures magnetic permeability, a powder level sensor that uses a piezoelectric vibrator, or another sensor may be employed as the sensors 131 and 134.

A spiral toner conveyance structure is formed inside the toner bottle 140Y. When a toner supply instruction to the hopper 132 is received, the toner bottle 140Y rotates and the toner in the toner bottle 140Y is conveyed toward the supply port by an effect of the toner conveyance structure. Furthermore, the toner bottle 140Y contracts according to the rotation. Accordingly, the toner in the toner bottle conveyed near the supply port is discharged from the supply port by a pumping effect accompanying the contraction of the toner bottle 140Y and is supplied to the hopper 132.

Since the toner consumed by the development device 114 is supplied from the toner bottle 140Y, when the image forming process continues, the toner remaining amount in the toner bottle 140Y will become less than the first predetermined amount after a while. Since the toner bottle 140Y is constituted to be detachable from the image forming apparatus 101, the image forming process is able to continue by replacing the toner bottle with a new toner bottle that contains toner.

FIG. 3 is a block diagram showing a hardware configuration of the image forming apparatus 101. A control device 500 that functions as an information processing apparatus includes a CPU 200, ROM 201, and RAM 202. The ROM 201, the RAM 202, the image processor 301, a toner supply processor 303, a memory 304, a maintenance service server 307, and an operation panel 171 are connected to the CPU 200. It should be noted that the CPU 200 is connected to the maintenance service server 307 through a network, such as the Internet, so as to enable communication. The CPU 200 has a timer.

The ROM 201 stores control programs that are executed by the CPU 200. The RAM 202 stores various kinds of information and provides a work area that is used when the CPU 200 runs the control programs. When a print job is input from a PC (personal computer (not show)) or the operation panel 171, the CPU 200 gives commands to the image processor 301 and toner supply processor 303.

The image processor 301 obtains image pixel information corresponding to an image to output. Then, the image processor 301 generates a laser emission command to control light-emitting timings of the scanner unit 117 according to the image pixel information. The image pixel information is used also for prediction of a toner use amount. The toner supply processor 303 decides operation timings of the supply screw 133 and toner bottle 140Y on the basis of the detection results of the sensors 131 and 134, and rotates motors for driving them. The toner supply processor 303 counts the number of times of driving and rotating the toner bottle 140Y as a toner supply count and stores it in the RAM 202.

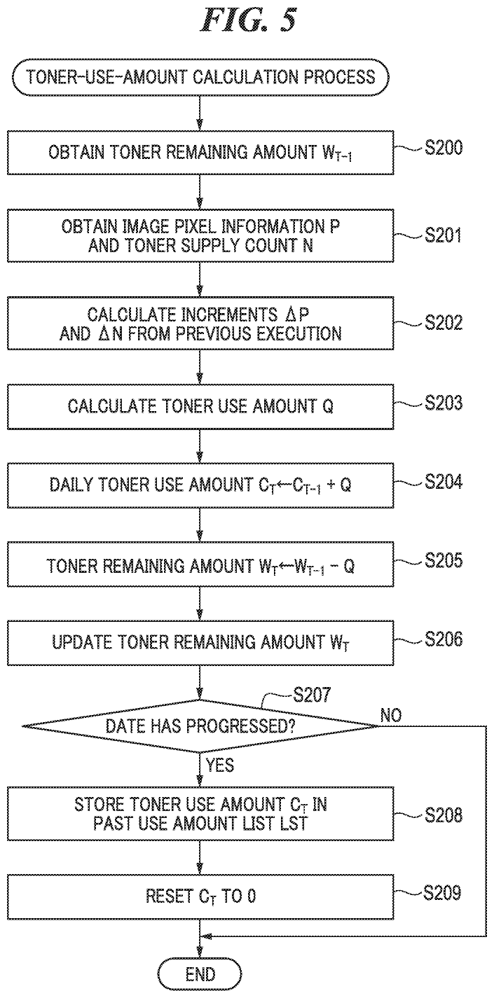

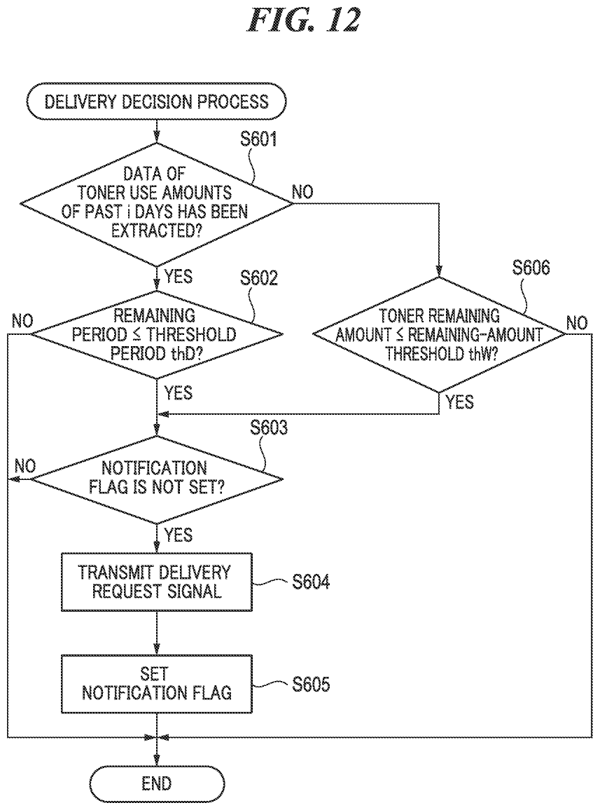

The memory 304 is provided in the toner bottle 140Y. Memories are provided also in the other toner bottles 140M, 140C, and 140Bk. The CPU 200 is able to read and rewrite the information stored in the memory 304. The memory 304 stores remaining amount information that shows the toner remaining amount in the toner bottle 140Y and information that enables distinguishment of whether the delivery request signal has been issued to the maintenance service server 307. The delivery request signal is used to request delivery of a toner bottle for replacement (replaceable consumable) from the maintenance service server 307. When a toner bottle is unused, a weight of toner that has been filled at a time of production is recorded in the memory 304 as the remaining amount information. The CPU 200 calculates a new toner remaining amount by subtracting successively a predicted value of the toner use amount that is obtained for every calculation from the remaining amount information that is obtained from the memory 304 according to the below-mentioned method (FIG. 5). And then, the CPU 200 updates the toner remaining amount as the remaining amount information in the memory 304. When determining that replacement of the toner bottle 140Y is needed, the CPU 200 notifies the maintenance service server 307 of the delivery request signal (mentioned later by referring to FIG. 12).

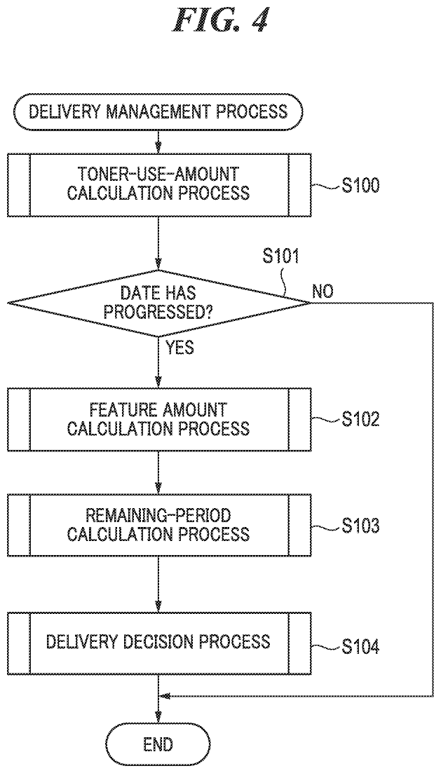

FIG. 4 is a flowchart showing a delivery management process executed by the image forming apparatus 101. This process is achieved when the CPU 200 develops a program stored in the ROM 201 to the RAM 202 and runs it. This process is executed periodically (every second, for example). Furthermore, this process is executed for every toner bottle 140Y, 140M, 140C, and 140Bk.

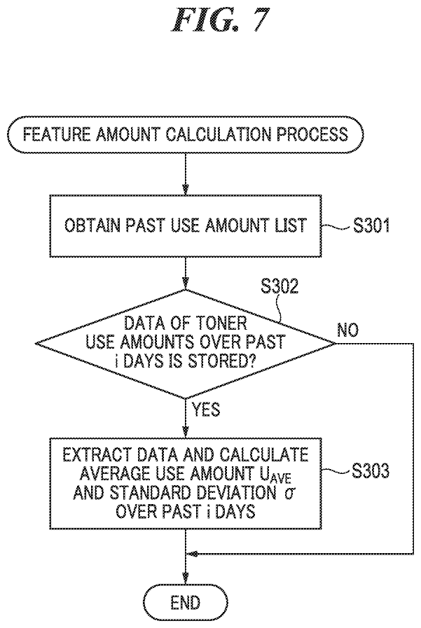

In step S100, the CPU 200 generates a past use amount list LST that is a history of a one-day toner use amount C_{T} by executing a toner-use-amount calculation process (FIG. 5) mentioned later. In step S101, the CPU 200 obtains date information and determines whether the date has progressed from the date on which the previous one-day toner use amount C_{T} has been obtained. When the date has not progressed, the CPU 200 finishes the delivery management process shown in FIG. 4. In the meantime, when the date has progressed, the CPU 200 extracts an average use amount U_{AVE} and a standard deviation σ as feature amounts of the user who uses the image forming apparatus 101 by executing a feature amount calculation process (FIG. 7) mentioned later in step S102. The average use amount U_{AVE} is an average of the toner use amounts C_{T} over the latest past predetermined period i (for example, 30 days). The standard deviation σ is a standard deviation of the toner use amounts C_{T} in the above-mentioned predetermined period i.

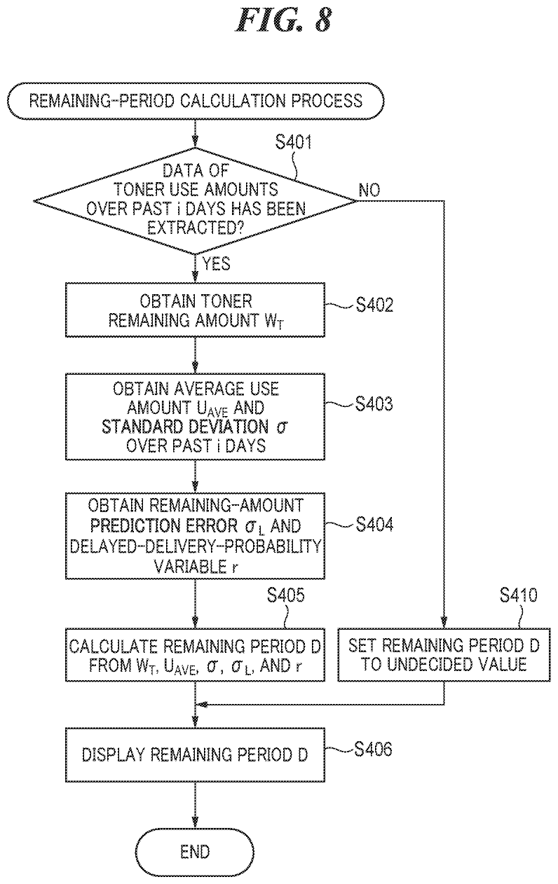

In step S103, the CPU 200 calculates the number D of remaining days (referred to as a remaining period D) that is estimated according to a future change of a remaining amount of a consumable by executing a remaining-period calculation process (FIG. 8) mentioned later. The remaining period D is a “usable period” until a day on which the toner amount decreases to such an extent that the toner bottle that is equipped currently becomes unavailable. In other words, the remaining period D is the number of days until a day on which the toner remaining amount becomes less than the first predetermined amount. Accordingly, the remaining period D is an estimated value of the remaining usable period of the toner bottle. The calculated remaining period D is stored in the RAM 202, for example. In step S104, the CPU 200 determines whether the delivery request signal should be issued by executing a delivery decision process (FIG. 12) mentioned later. Then, the CPU 200 finishes the delivery management process shown in FIG. 4.

FIG. 5 is a flowchart showing the toner-use-amount calculation process executed in the step S100 in FIG. 4. This process started at time T. In step S200, the CPU 200 obtains a toner remaining amount W_{T-1} updated by the last calculation (time T−1) from the memory 304. In the next step S201, the CPU 200 obtains image pixel information P and a toner supply count N from the image processor 301 and the toner supply processor 303, respectively. The image pixel information P and the toner replenishment count N are values accumulated according to an image output. In the next step S202, the CPU 200 calculates an increment ΔP of the image pixel information P and an increment ΔN of the toner supply count from the last calculation.

In the embodiment, representation values for the toner use amount per one pixel of an image and the toner supply amount per toner supply are found experimentally beforehand. For example, the toner use amount per one pixel of an image is 0.015 [mg] and the toner supply amount per toner supply is 180 [mg]. In step S203, the CPU 200 calculates a toner use amount Q during one step of calculation according to a formula 1 by using the average of the estimated values of the toner use amounts that are based on the estimated values of the toner use amounts on the basis of output images and the supply amount from the toner bottle.

$$Q [ mg ] = \frac{0 .015 Δ P + 180 \cdot Δ N}{2} \qquad [ Formula 1 ]$$

In step S204, the CPU 200 calculates the accumulated toner use amount C_{T} of the date on which this process is executing. The CPU 200 calculates the accumulated toner use amount C_{T} at the time T by adding the toner use amount Q to an accumulated toner use amount C_{T-1} that has been found at the time of the last calculation. In step S205, the CPU 200 finds for a toner remaining amount W_{T} at the time T by subtracting the toner use amount Q from the toner remaining amount W_{T-1}. Then, in step S206, the CPU 200 updates the toner remaining amount W_{T} stored in the memory 304 as the remaining amount information to the toner remaining amount W_{T} found in the step S205.

In step S207, the CPU 200 obtains the date information and determines whether the date has progressed from the time of the last calculation. Then, when the date has not progressed, the CPU 200 finishes the toner-use-amount calculation process shown in FIG. 5. In this case, the accumulated toner use amount C_{T} will be accumulated from the next calculation. In the meantime, when the date has progressed, the CPU 200 settles the current accumulated toner use amount C_{T} as a today's toner use amount and stores it in the past use amount list LST. The past use amount list LST is stored in the RAM 202 as a memory means, for example. It should be noted that the past use amount list LST may be stored in another storage unit that keeps memory even if the power of the image forming apparatus 101 is turned OFF. After that, the CPU 200 resets the accumulated toner use amount C_{T} in that day to 0 and finishes the toner-use-amount calculation process shown in FIG. 5.

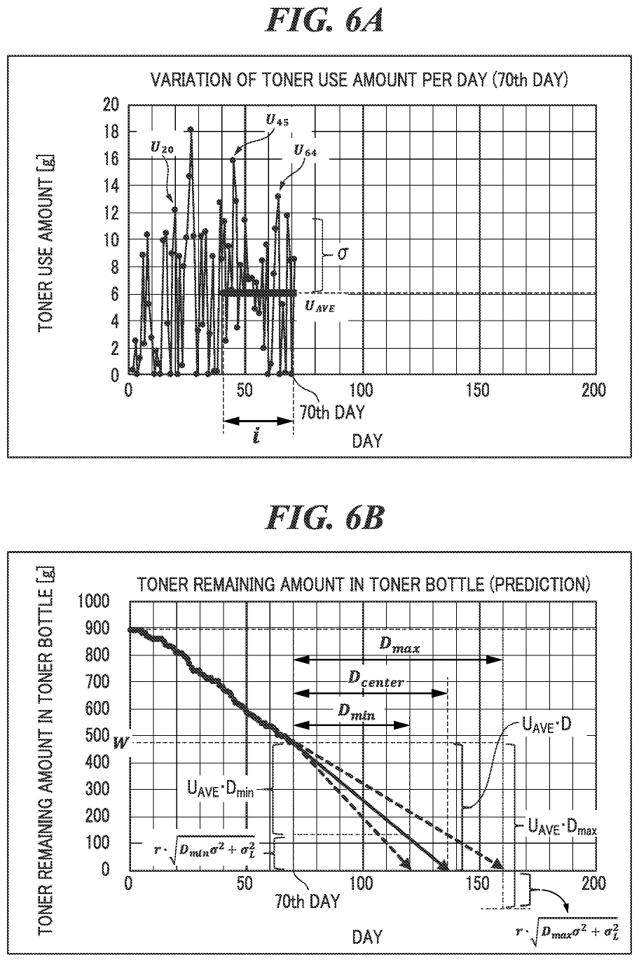

FIG. 6A is a graph showing variation of a toner use amount per day by a certain user. Each dot indicates the toner use amount per day of each date. The toner amounts over 70 days from the beginning of use of the toner bottle are shown. FIG. 6A shows the toner use amounts U20, U45, and U64 of 20th day, 45th day, and 64th day. FIG. 6B is a graph showing variation of the toner remaining amount that is obtained by subtracting the toner use amount per day from an initial toner amount (0th day) every day. The toner remaining amount of 70th day is W.

FIG. 7 is a flowchart showing a feature amount calculation process executed in the step S102 in FIG. 4. First, in step S301, the CPU 200 obtains the past use amount list LST stored in the step S208 in FIG. 5 from the RAM 202. In the next step S302, the CPU 200 determines whether data (toner use amounts C_{T}) over the predetermined period i (30 days) is stored in the past use amount list LST obtained. The reason why determining whether data over past i days is stored is that it is known that the information about the toner use amounts C_{T} as the consumption amount of at least past i days is required for predicting the remaining period D mentioned later with sufficient accuracy as a result of an experiment and analysis. It should be noted that the predetermined period i is not limited to 30 days exemplified. Moreover, a unit of the predetermined period i is not limited to a day. When a certain time length is a unit period, a plurality of unit periods may be the predetermined period i.

When data of the toner use amounts C_{T} in the past predetermined period i is not stored in the past use amount list LST obtained, the CPU 200 finishes the feature amount calculation process shown in FIG. 7 because the remaining period D cannot be predicted with sufficient accuracy. In the meantime, when data of the toner use amounts C_{T} in the past predetermined period i is stored in the past use amount list LST obtained, the CPU 200 extracts the data of the toner use amounts C_{T} in the past predetermined period i and calculates an average use amount U_{AVE} and a standard deviation σ over the predetermined period i from the extracted data in step S303. When a toner use amount of n days ago shall be Un, the average use amount U_{AVE} and the standard deviation σ are respectively calculated with formulas 2 and 3. It should be noted that σ=0 in a case of i=1.

$$\begin{matrix}{U}_{AVE} = \frac{{\sum }_{n = 1}^{i} {U}_{n}}{i} & [ Formula 2 ] \\ σ = \sqrt{\frac{{\sum }_{n = 1}^{i} {( {U}_{n} - {U}_{AVE} )}^{2}}{i - 1}} & [ Formula 3 ]\end{matrix}$$

FIG. 8 is a flowchart showing the remaining-period calculation process executed in the step S103 in FIG. 4. In step S401, the CPU 200 determines whether the data over the predetermined period i has been extracted from the past use amount list LST. In this step, the CPU 200 determines Yes in a case where the step S303 has been executed in the feature amount calculation process (FIG. 7) executed immediately before. It should be noted that the CPU 200 may determine whether the data over the predetermined period i has been extracted from the past use amount list LST by whether the data (toner use amounts C_{T}) over the predetermined period i is stored in the past use amount list LST obtained. When the data over the predetermined period i cannot be extracted from the past use amount list LST, the CPU 200 sets the remaining period D to a value showing an undecided state in step S410 because a suitable remaining period D cannot be calculated. The value showing the undecided state is the number of days (for example, 999 days) defined beforehand. The undecided value is displayed on the operation panel 171 to show that the remaining period is undecided. Another value may be used as the undecided value. After that, the CPU 200 proceeds with the process to step S406.

In the meantime, when the data over the predetermined period i has been extracted from the past use amount list LST, the CPU 200 obtains the toner remaining amount W_{T} calculated in the step S205 in FIG. 5 in step S402. The toner remaining amount W_{T} corresponds to the remaining usable amount of the toner bottle.

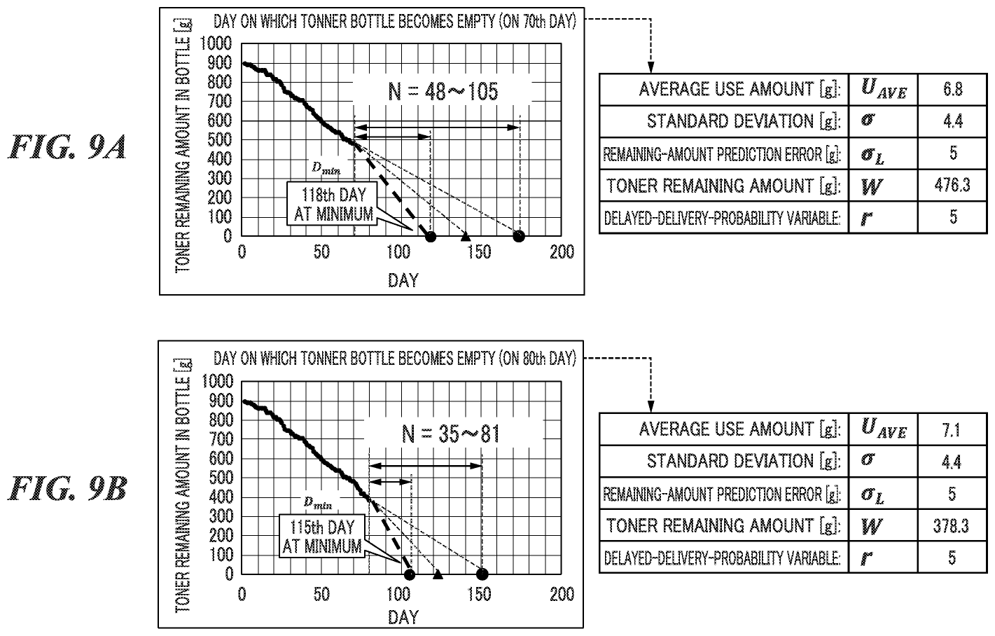

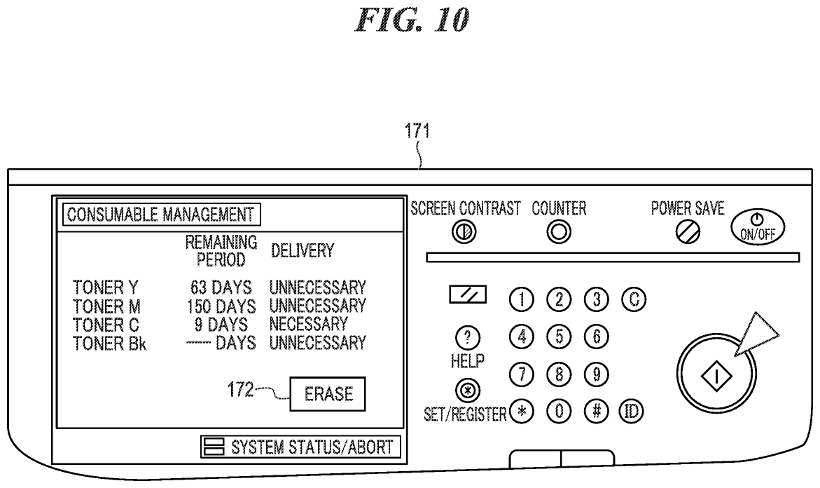

In the next step S403, the CPU 200 obtains the average use amount U_{AVE} and the standard deviation σ that are calculated in the step S303 in FIG. 7. In step S404, the CPU 200 obtains a remaining-amount prediction error σ_{L} and a delayed-delivery-probability variable r that are beforehand stored in the RAM 202. It should be noted that the remaining-amount prediction error σ_{L} is a value found by an experiment and is a prediction error of the toner remaining amount after D days. The delayed-delivery-probability variable r is a variable to which a permission level for the occurrence probability of a delayed delivery is voluntarily set. When the variable r increases, the occurrence probability of the delayed delivery decreases and the probability of early delivery increases. In step S405, the CPU 200 calculates the remaining period D by using the values of W_{T}, U_{AVE}, σ, σ_{L}, and r. The calculation method for the remaining period D and its display are mentioned later by referring to FIG. 9A, FIG. 9B, and FIG. 10.

In the next step S406, the remaining period D found in the step S405 is displayed on the operation panel 171. FIG. 10 is a display example of a consumable management screen displayed on the operation panel 171. The remaining period D and the information about the necessity of delivery are displayed on the consumable management screen for every kind of consumable (every toner bottle), for example. Pieces of information about the toner bottles 140Y, 140M, 140C, and 140Bk are respectively indicated in correspondence with the toners Y, M, and C and Bk. About the toner Bk, since the data of the toner use amounts over the past predetermined period i is not stored, the remaining period D is not calculated and the value showing the undecided state is displayed as the remaining period D. In the display of the remaining period D about the toner Bk, “---” is displayed as the value showing the undecided state. Since the display of the value showing the undecided state is enough to be distinguished from the remaining period D that is definitely found, other character strings, such as “Under Studying” and “999 Days”, may be displayed.

The calculation of the remaining period D in the step S405 will be described. The calculation of the remaining period D assumes that the same feature of usage in the past predetermined period i will continue over D days from the present time (the same toner consumption will continue). The calculation uses a toner use amount (center value) U_{AVE}·D after D days, a standard deviation √(σ²·D) after D days, and a remaining-amount prediction error σ_{L} after D days in addition to the remaining-amount prediction error σ_{L} and the delayed-delivery-probability variable r. FIG. 6B shows a minimum value Dmin, a maximum value Dmax, and an intermediate value Dcenter of the remaining period D. The average use amount U_{AVE} is found with a formula 4. The remaining period D is found with a formula 5 by solving the formula 4 for D. Accordingly, the minimum value Dmin is found with a formula 6, and the maximum value Dmax is found with a formula 7.

$$\begin{matrix}W = {U}_{A V E} \cdot D + r \sqrt{D {σ}^{2} + {σ}_{L}^{2}} & [ Formula 4 ] \\ D = \frac{2 {U}_{AVE} W + {r}^{2} {σ}^{2} \pm \sqrt{\begin{matrix}{r}^{4} {σ}^{4} + 4 {U}_{AVE} {Wr}^{2} {σ}^{2} + \\ 4 {U}_{AVE}^{2} {r}^{2} {σ}_{L}^{2}\end{matrix}}}{2 {U}_{AVE}^{2}} & [ Formula 5 ] \\ {D}_{min} = \frac{2 {U}_{AVE} W + {r}^{2} {σ}^{2} - \sqrt{\begin{matrix}{r}^{4} {σ}^{4} + 4 {U}_{AVE} {Wr}^{2} {σ}^{2} + \\ 4 {U}_{AVE}^{2} {r}^{2} {σ}_{L}^{2}\end{matrix}}}{2 {U}_{AVE}^{2}} & [ Formula 6 ] \\ {D}_{max} = \frac{2 {U}_{AVE} W + {r}^{2} {σ}^{2} + \sqrt{\begin{matrix}{r}^{4} {σ}^{4} + 4 {U}_{AVE} {Wr}^{2} {σ}^{2} + \\ 4 {U}_{AVE}^{2} {r}^{2} {σ}_{L}^{2}\end{matrix}}}{2 {U}_{AVE}^{2}} & [ Formula 7 ]\end{matrix}$$

FIG. 9A and FIG. 9B are views showing specific examples for finding the remaining period D with the above-mentioned formulas. The term “EMPTY” in FIG. 9A and FIG. 9B means that the toner remaining amount in the toner bottle becomes less than the first predetermined amount and does not mean that the toner remaining amount becomes nix (zero).

FIG. 9A is the view showing transition (a future change of a remaining amount of a consumable) that is used to predict a day on which the toner bottle becomes empty on 70th day (the toner remaining amount W=476.3 g) from the first use of the new toner bottle. When the average use amount U_{AVE} per day over past 30 days on the 70th day is equal to 6.8 g, when the standard deviation σ of the use amounts per day over the past 30 days is equal to 4.4 g, when the remaining-amount prediction error σ_{L} is equal to 5 g, and when the delayed-delivery-probability variable r is equal to 5, the minimum value Dmin of the remaining period D becomes 48 days and the maximum value Dmax becomes 105 days. Accordingly, it is presumed that the toner bottle will become empty on the remaining 48 days (118 days from the first use) at the shortest or on the remaining 105 days (175 days from the first use) at the longest.

FIG. 9B is the view showing transition (a future change of a remaining amount of a consumable) that is used to predict a day on which the toner bottle becomes empty on 80th day (the toner remaining amount W=378.3 g) from the first use of the new toner bottle. When the average use amount U_{AVE} per day over past 30 days on the 80th day is equal to 7.1 g, when the standard deviation σ of the use amounts per day over the past 30 days is equal to 4.4 g, when the remaining-amount prediction error σ_{L} is equal to 5 g, and when the delayed-delivery-probability variable r is equal to 5, the minimum value Dmin of the remaining period D becomes 35 days and the maximum value Dmax becomes 81 days. Accordingly, it is presumed that the toner bottle will become empty on the remaining 35 days (115 days from the first use) at the shortest or on the remaining 81 days (161 days from the first use) at the longest.

In the embodiment, the minimum value Dmin is employed as the remaining period D that is the usable period of the toner bottle. In the meantime, the center value Dcenter, the maximum value Dmax, or the intermediate value between the minimum value Dmin and maximum value Dmax may be employed. Particularly, it is preferable to employ the shortest minimum value Dmin about an indispensable consumable like a toner bottle containing toner (i.e., lack of the toner stops the image forming apparatus) from a view point of reducing the risk of an operation stop as much as possible. Even when daily usage of a user varies, the remaining period D is predictable with sufficient accuracy by calculating and updating the day on which the toner remaining amount will become zero successively on the basis of the feature of the usage. It should be noted that the probability that prevents delayed delivery is settable arbitrarily by adjusting the I delayed-delivery-probability variable r.

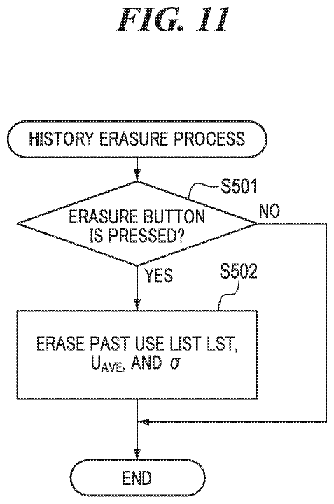

As shown in FIG. 10, an erasure button 172 is displayed in the consumable management screen on the operation panel 171. FIG. 11 is a flowchart showing a history erasure process. This process is achieved when the CPU 200 develops a program stored in the ROM 201 to the RAM 202 and runs it. This process is executed periodically (every second, for example). Although this process is executed in common for all the toner bottles 140Y, 140M, 140C, and 140Bk, it may be executed for every toner bottle.

In step S501, the CPU 200 determines whether the erasure button 172 is pressed. When the erasure button 172 is not pressed, the CPU 200 finishes the history erasure process shown in FIG. 11. In the meantime, when the erasure button 172 is pressed (i.e., when user instruction information is received), the CPU 200 erases user's use history stored in the RAM 202 in step S502. That is, the CPU 200 erases the data (toner use amounts C_{T}) in the past use amount list LST, the average use amount U_{AVE}, and the standard deviation σ. Immediately after erasing the user's use history, the data of the toner use amounts CT over the past predetermined period i is not stored in the past use amount list LST.

The erasure button 172 is operated by a service person or a user when a user is changed because the image forming apparatus 101 is moved to another section in a company, for example. Accordingly, even when the feature of the toner consumption is changed, the remaining period D suitable for a new user can be recalculated without being influenced by the history of the feature amount of the previous user. Although the erasure button 172 is provided in the consumable management screen as an erasing means to erase a user's use history, an aspect of the erasing means is not limited to this. For example, the use history may be erased by a command from a PC. Alternatively, the use history may be erased in conjunction with initialization of various data stored in the image forming apparatus 101.

FIG. 12 is a flowchart showing a delivery decision process executed in the step S104 in FIG. 4. There are two methods for determining whether the delivery request signal for instructing delivery of a toner bottle for replacement is issued toward the maintenance service server 307. One method uses the remaining period D, and the other method uses the toner remaining amount W_{T}. The method of using the remaining period D has higher decision accuracy among the two methods. This is because the remaining period D is reflecting the use mode of a user strongly. For example, a case where the delivery request signal is issued when the toner remaining amount becomes below a certain remaining-amount threshold (10%) will be thought. Since the consumption velocity depends on a user, the number of days in which toner becomes empty also depends on a user. Accordingly, when the remaining-amount threshold is uniformly set as the same value, the delivery may be delayed for a user who consumes a huge amount of toner. In the meantime, while a new user's use history is extracting after erasing the past user's use history, it is not appropriate to employ the method of using the remaining period D, because the remaining period D cannot be calculated or the remaining period D cannot be calculated at high accuracy. Accordingly, the CPU 200 employs the method of using the toner remaining amount W_{T} while the remaining period D cannot be calculated.

In step S601, the CPU 200 determines whether the data over the predetermined period i has been extracted from the past use amount list LST. This process is the same as the step S401 in FIG. 8. When the data over the predetermined period i has been extracted from the past use amount list LST, the suitable remaining period D is found. Accordingly, the CPU 200 executes the process from step S602 to decide whether a delivery request signal will be issued on the basis of the remaining period D. In the meantime, when the data over the predetermined period i has not been extracted from the past use amount list LST, the suitable remaining period D has not been found. Accordingly, the CPU 200 proceeds with the process to step S606 to decide whether a delivery request signal will be issued on the basis of the remaining toner amount W_{T}.

In the step S602, the CPU 200 determines whether the remaining period D found in the step S406 is equal to or less than the number of days for a threshold (threshold period) thD. The threshold period thD (for example, ten days) is beforehand stored in the ROM 201 or the RAM 202. The threshold period thD is set by adding a predetermined margin to a period needed until a new toner bottle arrives after notifying the maintenance service server 307 of the delivery request signal, for example. When the remaining period D exceeds the threshold period thD, the CPU 200 decides not to perform the delivery request and finishes the delivery decision process shown in FIG. 12 without performing the delivery request because continuous use of the toner bottle is available.

In the meantime, when the remaining period D is equal to or less than the threshold period thD, the CPU 200 determines in step S603 whether a notification flag is set because the continuous use of the toner bottle will be unavailable soon. When the notification flag has been already set, the CPU 200 finishes the delivery decision process shown in FIG. 12. This is because of avoiding duplicated transmission of the delivery request signal. In the meantime, when the notification flag is not set, the CPU 200 decides to perform the delivery request in step S604, transmits the delivery request signal to the operation panel 171, and notifies the maintenance service server 307 of the delivery request signal through the network. In step S605, the CPU 200 sets the notification flag, stores the notification flag in the memory 304, and then finishes the delivery decision process shown in FIG. 12. When receiving the delivery request signal, the operation panel 171 displays necessity of delivery on the consumable management screen as shown in FIG. 10. In the meantime, the maintenance service server 307 that received the delivery request signal arranges the delivery of a new toner bottle to the user of the image forming apparatus 101.

In step S606, the CPU 200 determines whether the toner remaining amount W_{T} stored in the memory 304 is equal to or less than a remaining-amount threshold (threshold amount) thW. The remaining-amount threshold thW is decided until installation of the image forming apparatus 101. The remaining-amount threshold thW is 10%, for example, but is not limited to 10%. It should be noted that a service person or a user is able to change the setting value of the remaining-amount threshold thW after installation of the image forming apparatus 101. The initial value of the remaining-amount threshold thW is stored in the ROM 201, and is read to the RAM 202. It should be noted that the remaining-amount threshold thW may be stored in another storage unit that keeps memory even if the power of the image forming apparatus 101 is turned OFF. When the toner remaining amount W_{T} exceeds the remaining-amount threshold thW, the CPU 200 finishes the delivery decision process shown in FIG. 12 without performing the delivery request because continuous use of the toner bottle is available.

In the meantime, when the toner remaining amount W_{T} is equal to or less than the remaining-amount threshold thW, the CPU 200 executes the process from the step S603 because the continuous use of the toner bottle may be unavailable soon. The transition of the process from the step S601 to the step S606 reduces delay of delivery of a toner bottle as much as possible even in a case where the suitable remaining period D cannot be calculated because the data over the predetermined period i has not been extracted from the past use amount list LST.

According to the embodiment, the CPU 200 determines whether the delivery request is performed on the basis of the estimated usable period (remaining period D) when the consumption (toner use amounts C_{T}) over the predetermined period i has been extracted from the past use amount list LST (S602). In the meantime, the CPU 200 determines whether the delivery request is performed on the basis of the remaining usable amount (toner remaining amount W_{T}) in the toner bottle when the toner use amounts C_{T} over the predetermined period i has not been extracted from the past use amount list LST (S606). Accordingly, even in a case where the past use amount list LST that is the history of the consumption amounts of the toner in the toner bottle is erased, delayed delivery of a toner bottle as a consumable is reduced. It should be noted that the determinations in the steps S602 and S606 correspond to a determination of whether a predetermined condition about a remaining amount of a consumable is satisfied.

Next, a second embodiment of the present invention will be described. In the first embodiment, the remaining-amount threshold thW is designated by a user etc. As compared with this, in the second embodiment, the remaining-amount threshold thW is set up dynamically. The second embodiment is different from the first embodiment in the delivery decision process. The other configurations are the same as that in the first embodiment.

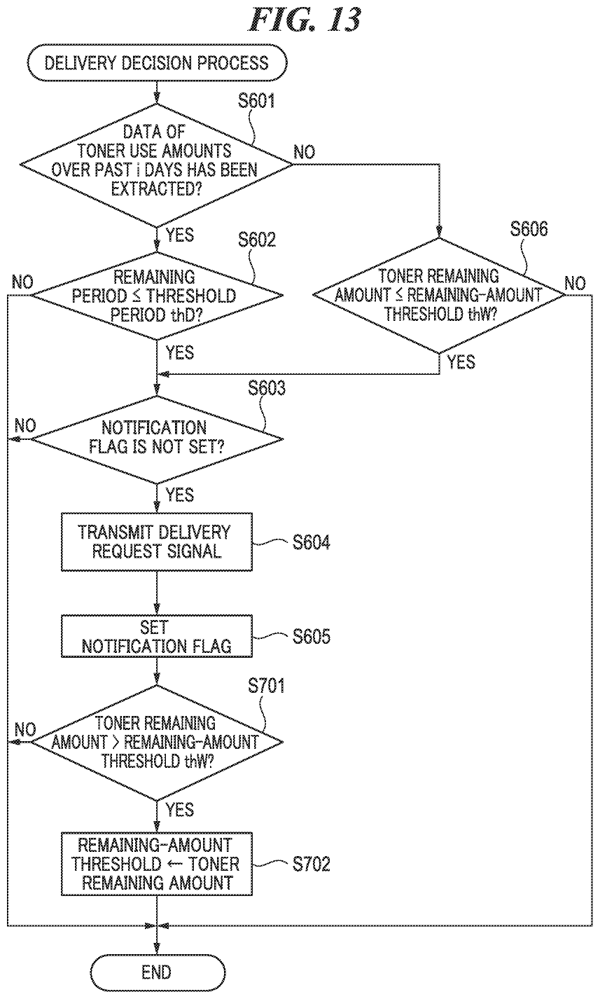

FIG. 13 is a flowchart showing the delivery decision process executed in the step S104 in FIG. 4 in the second embodiment. The processes in the steps S601 through S605 are the same as the corresponding steps in FIG. 12. Following the step S605, the CPU 200 determines whether the toner remaining amount W_{T} stored in the memory 304 is more than the current remaining-amount threshold thW in step S701. Since the remaining-amount threshold thW may be updated whenever this process is executed, the current remaining-amount threshold thW is obtained as a target for comparison in the step S701. It should be noted that the remaining-amount threshold thW is stored in a readable and writable nonvolatile memory.

As a result of determination in the step S701, when the toner remaining amount W_{T} is not more than the current remaining-amount threshold thW, the CPU 200 finishes the delivery decision process shown in FIG. 13. In the meantime, when the toner remaining amount W_{T} is more than the current remaining-amount threshold thW, the CPU 200 updates the remaining-amount threshold thW to the toner remaining amount W_{T} in step S702. Thereby, the remaining-amount threshold thW is updated to the toner remaining amount W_{T} at the time of transmitting the delivery request signal. Accordingly, the remaining-amount threshold thW is kept or increases by repeating this process. Accordingly, the remaining-amount threshold thW always takes the maximum value among the values at the times of transmitting the delivery request signal in the past. Then, the CPU 200 finishes the delivery decision process shown in FIG. 13.

According to the second embodiment, even in a case where the past use amount list LST has been erased, the same effect as the first embodiment is achieved about the reduction of the delayed delivery of a toner bottle. Furthermore, since the remaining-amount threshold thW is set to the maximum value among the usable amounts (toner remaining amounts W_{T}) obtained at the times of transmitting the delivery request signal in the past, the delayed delivery of a toner bottle is reduced more certainly.

It should be noted that the CPU 200 may determine whether the data over the predetermined period i is stored in the obtained past use amount list LST in the step S601 in FIG. 12 or FIG. 13 in place of determining whether the data over the predetermined period i has been extracted from the past use amount list LST. Alternatively, the CPU 200 may determine whether the remaining period D has been calculated in the step S405 of the remaining-period calculation process shown in FIG. 8.

Although a toner bottle is exemplified as a consumable in the embodiments, a consumable is not limited to a toner bottle. A photosensitive member 111 may be a consumable. When a consumable does not contain consumption material like toner, a consumption amount corresponds to the toner use amount C_{T} and a usable amount corresponds to the toner remaining amount W_{T}.

Although the standard deviation σ is used as one of the feature amounts of a user, a dispersion that squares the standard deviation may be used.

It should be noted that the method shown in FIG. 5 is not indispensable to obtain the remaining usable amount (toner remaining amount W_{T}) of the consumable. For example, the toner remaining amount W_{T} may be obtained from a detection result of a remaining amount sensor provided in the toner bottle.

Although the present invention has been described in detail on the basis of the suitable embodiments, the present invention is not limited to these specific embodiments and includes various configurations that do not deviate from the scope of the present invention. Parts of the above-mentioned embodiments may be combined suitably.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-092905, filed May 16, 2019, which is hereby incorporated by reference herein in its entirety.

What is claimed is:

1. An information processing apparatus that enables communication with an image forming apparatus that has a consumable, the consumable being replaceable, the information processing apparatus comprising:
a memory that stores data related to a consumption amount of the consumable; and
a controller configured to:
determine a future change of a remaining amount of the consumable from the data stored in the memory;
output a delivery request that requests delivery of a replacement consumable based on the future change of the remaining amount of the consumable; and
receive user instruction information,
wherein the controller outputs the delivery request in a case where a predetermined condition related to the remaining amount of the consumable is satisfied in a predetermined period from reception of the user instruction information.

2. The information processing apparatus according to claim 1, wherein the consumable includes toner.

3. The information processing apparatus according to claim 1, wherein the data includes the remaining amount of the consumable.

4. The information processing apparatus according to claim 1, wherein the data includes a use amount of the consumable.

5. The information processing apparatus according to claim 1, wherein the predetermined condition is satisfied in a case where the remaining amount of the consumable is less than a threshold amount.

6. The information processing apparatus according to claim 1, wherein the controller determines a remaining period to replacement time of the consumable according to the future change of the remaining amount of the consumable, and
wherein the controller outputs the delivery request in a case where the remaining period is less than a threshold period.

7. The information processing apparatus according to claim 1, further comprising a display,
wherein the controller determines a remaining period to replacement time of the consumable based on the future change of the remaining amount of the consumable, and
wherein the controller displays the remaining period on the display.

8. The information processing apparatus according to claim 1, wherein the user instruction information includes information instructing erasure of the data stored in the memory.

9. The information processing apparatus according to claim 1, wherein the user instruction information includes information instructing that an installation location of the image forming apparatus is changed.

10. An image forming apparatus that has a consumable, the consumable being replaceable, the image forming apparatus comprising:
a memory that stores data related to a consumption amount of the consumable;
a controller configured to:
determine a future change of a remaining amount of the consumable from the data stored in the memory;
output a delivery request that requests delivery of a replacement consumable based on the future change of the remaining amount of the consumable; and
receive user instruction information,
wherein the controller outputs the delivery request in a case where a predetermined condition related to the remaining amount of the consumable is satisfied in a predetermined period from reception of the user instruction information.

11. A control method for an image forming apparatus that has a consumable and a memory storing data related to a consumption amount of the consumable, the control method comprising:
determining a future change of a remaining amount of the consumable from the data stored in the memory;
outputting a delivery request that requests delivery of a replacement consumable based on the future change of the remaining amount of the consumable; and
receiving user instruction information,
wherein the delivery request is outputted in a case where a predetermined condition related to the remaining amount of the consumable is satisfied in a predetermined period from reception of the user instruction information.
